(19) United States
(12) Patent Application Publication
(10) Pub. No.: US 2025/0094791 A1
(43) Pub. Date: Mar. 20, 2025

(54) VALUE-DEPENDENT QUANTIZATION FOR MACHINE LEARNING

(71) Applicant: Seagate Technology LLC, Fremont, CA (US)

(72) Inventors: Foo Yee YEO, Singapore (SG); Yasaman KESHTKARJAHROMI, Shakopee, MN (US); Paul Roger HEATH, Shakopee, MN (US)

(21) Appl. No.: 18/759,483

(22) Filed: Jun. 28, 2024

Related U.S. Application Data
(60) Provisional application No. 63/582,741, filed on Sep. 14, 2023.

(51) Int. Cl. G06N 3/0495; G06F 17/16

(52) U.S. Cl. CPC G06N 3/0495; G06F 17/16

(57) ABSTRACT

A computing system determines a maximum field size for a field containing values of quantized versions of a weight matrix, an input data matrix, and a bias matrix and determines a weight upper bound of scaling factors for the weight matrix based on values of the weight matrix, an input data upper bound of scaling factors for the input data matrix based on values of the input data matrix, and a bias upper bound of scaling factors for the bias matrix based on values of the bias matrix. The computing system also sets a weight scaling factor of the weight matrix, an input data scaling factor of the input data matrix, and a bias scaling factor for the bias matrix in two different cases: when the sum is less than or equal to the bias upper bound and when the sum is greater than the bias upper bound.

### CROSS-REFERENCE WITH RELATED APPLICATIONS

The present application claims the benefit of priority to U.S. Provisional Patent Application No. 63/582,741, entitled “Near-Perfect Quantization Method for Private and Verifiable ML with Minimal Impact on Accuracy” and filed on Sep. 14, 2023, which is specifically incorporated by reference for all that it discloses and teaches.

### SUMMARY

In some aspects, the techniques described herein relate to a computing-processor-implemented method for quantizing linear operations of machine learning computations, the computing-processor-implemented method including: determining a maximum field size for a field containing values of a quantized version of a weight matrix, a quantized version of an input data matrix, and a quantized version of a bias matrix; determining a weight upper bound of scaling factors for the weight matrix based on values of elements of the weight matrix and the maximum field size, an input data upper bound of scaling factors for the input data matrix based on values of elements of the input data matrix and the maximum field size, and a bias upper bound of scaling factors for the bias matrix based on values of elements of the bias matrix and the maximum field size; setting a weight scaling factor of the weight matrix to the weight upper bound, an input data scaling factor of the input data matrix to the input data upper bound, and a bias scaling factor for the bias matrix to a sum of the weight upper bound and the input data upper bound, when the sum is less than or equal to the bias upper bound; and setting the bias scaling factor for the bias matrix to the bias upper bound and the weight scaling factor of the weight matrix and the input data scaling factor of the input data matrix based on the bias upper bound, when the sum is greater than the bias upper bound.

In some aspects, the techniques described herein relate to a computing system for quantizing linear operations of machine learning computations, the computing system including: one or more hardware computing processors; a field size bounding engine executable by the one or more hardware computing processors and configured to determine a maximum field size for a field containing values of a quantized version of a weight matrix, a quantized version of an input data matrix, and a quantized version of a bias matrix; a scaling factor bounding engine executable by the one or more hardware computing processors and configured to determine a weight upper bound of scaling factors for the weight matrix based on values of elements of the weight matrix and the maximum field size, an input data upper bound of scaling factors for the input data matrix based on values of elements of the input data matrix and the maximum field size, and a bias upper bound of scaling factors for the bias matrix based on values of elements of the bias matrix and the maximum field size; and a scaling factor assigner executable by the one or more hardware computing processors and configured to set a weight scaling factor of the weight matrix to the weight upper bound, an input data scaling factor of the input data matrix to the input data upper bound, and a bias scaling factor for the bias matrix to a sum of the weight upper bound and the input data upper bound, when the sum is less than or equal to the bias upper bound and to set the bias scaling factor for the bias matrix to the bias upper bound and the weight scaling factor of the weight matrix and the input data scaling factor of the input data matrix based on the bias upper bound, when the sum is greater than the bias upper bound.

In some aspects, the techniques described herein relate to one or more tangible processor-readable storage media embodied with instructions for executing on one or more processors and circuits of a computing device a process for quantizing linear operations of machine learning computations, the process including: determining a maximum field size for a field containing values of a quantized version of a weight matrix, a quantized version of an input data matrix, and a quantized version of a bias matrix; determining a weight upper bound of scaling factors for the weight matrix based on values of elements of the weight matrix and the maximum field size, an input data upper bound of scaling factors for the input data matrix based on values of elements of the input data matrix and the maximum field size, and a bias upper bound of scaling factors for the bias matrix based on values of elements of the bias matrix and the maximum field size; setting a weight scaling factor of the weight matrix to the weight upper bound, an input data scaling factor of the input data matrix to the input data upper bound, and a bias scaling factor for the bias matrix to a sum of the weight upper bound and the input data upper bound, when the sum is less than or equal to the bias upper bound; and setting the bias scaling factor for the bias matrix to the bias upper bound and the weight scaling factor of the weight matrix and the input data scaling factor of the input data matrix based on the bias upper bound, when the sum is greater than the bias upper bound.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example machine learning system for a neural network.

FIG. 2 illustrates an example system for quantizing weight values, input data values, and bias values for a neural network.

FIG. 3 illustrates an example computing system for quantizing linear operations of neural network calculations.

FIG. 4 illustrates example operations of a computing-processor-implemented method for quantizing linear operations of neural network calculations.

FIG. 5 illustrates an example computing device for use in implementing the described technology.

### DETAILED DESCRIPTIONS

Generally, a neural network includes a series of interconnected neurons in a series of layers. Each neuron is characterized by its own weight, bias, and activation function. The weights and biases in a neural network are typically referred to as “parameters” of the neural network, which are tuned during training. The activation of a neuron is based on both its weight and bias values, as well as the activation function used by the neuron.

The weights and biases of a neural network are often represented as matrices, wherein each element in a matrix corresponds to a parameter of each neuron. The weight matrix is denoted herein by W, and the bias matrix is denoted herein by B. Furthermore, input data and output data are also often represented matrices, and the input data matrix is denoted herein by A.

In applications of privacy-preserving and verifiable computation using neural networks, linear computations are performed over a finite field [symbol] . For example, it is a common practice to offload the heavy computations of large neural networks to powerful computing nodes. However, providing efficiency and security for these computing nodes from the viewpoint of both privacy and integrity is a challenge.

In many neural network architectures, a large percentage of computations in neural network architectures are devoted to linear operations, while a much lower percentage of computations are devoted to nonlinear operations. For example, in one deep convolutional neural network model, about 98.5% of the computational complexity corresponds to the linear computations, while only 1.5% corresponds to the nonlinear computations. Thus, linear operations (convolutions/matrix multiplication as well as adding biases) are good candidates for computation offloading.

Quantization of a neural network enables fast inference using efficient fixed-point operations in typical artificial intelligence hardware accelerators. Compared with floating point inference, quantization emphasizes and enhances integer computations, leading to smaller storage space requirements, a smaller memory footprint, lower power consumption, and faster inference speed, all of which are desirable for practical edge deployment. Therefore, quantization contributes to a model efficient pipeline.

Fixed point and floating point are different ways of representing numbers in computing devices. Floating point representation is designed to capture fine precisions (by dividing the bit field into mantissa and exponent) with high bit-width (typically 32 bits or 64 bits), whereas fixed point numbers reside on a fixed width grid that is typically much coarser (typically 4, 8, 16 bits). Due to the simplicity of fixed point arithmetic, the circuitry for fixed point arithmetic can be much cheaper, simpler, and more efficient than its floating point counterpart. The term “quantization” refers to the process of converting neural network models having floating point weights and operations into neural network models having fixed point weights and operations.

In addition, quantization can also maintain privacy and verifiability when applied to a machine learning model that supports privacy and verifiability. For example, quantization can convert the floating point numbers to integers, which can then be interpreted as elements of a finite field. Some implementations of a private and verifiable machine learning model require the parameter and data matrices to have elements from a finite field in order to work.

The described technology introduces quantization for the linear operations (convolutions/matrix multiplications including the added biases) of neural network calculations that reduces or nearly eliminates errors resulting from the quantization. When applying the described quantization techniques to a machine learning (ML) model, the model can still maintain privacy and verifiability. Generally, the described technology includes operations for determining the maximum field size of the field that includes the values of elements of quantized versions of parameter and data matrices, such as W, A, and B, wherein these matrices are used in the linear operation of WA+B, where W denotes the weight matrix, A denotes the input data matrix, and B denotes the bias matrix. Thereafter, the described technology includes operations for determining the best scale factor for quantizing the elements of W, A and B to avoid wrap around error while minimizing loss of accuracy for large neural networks. Accordingly, the described technology supports high-accuracy quantization of the weight matrix, the input data matrix, and the bias matrix. In testing, the described technology can exhibit little or no loss in accuracy when the described quantization method is applied to certain machine learning models. Furthermore, the described technology can be applied to the training and/or inference operations of the machine learning model. The described technology can also be applied to preserve privacy, maintain verifiability, and generally to enable a recovery of the original parameters and input data.

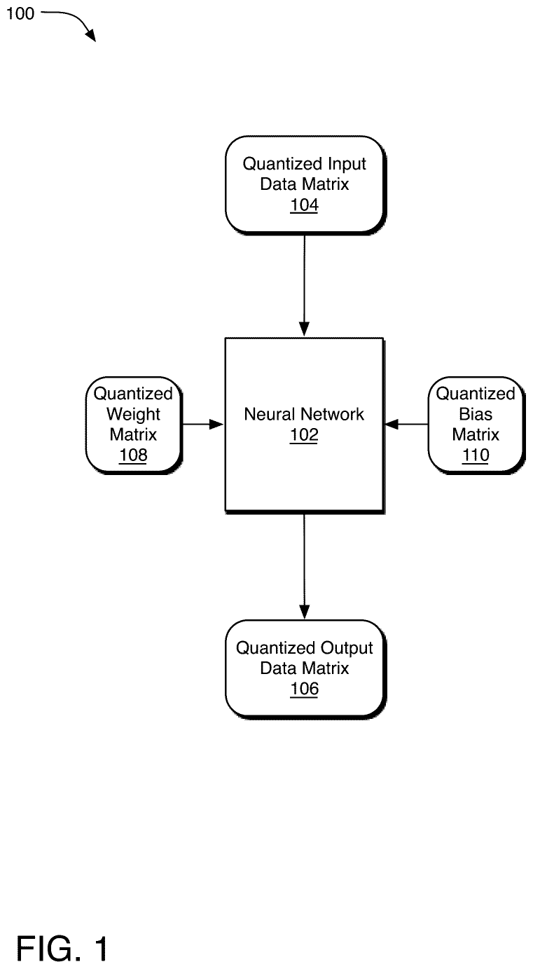

FIG. 1 illustrates an example machine learning system 100 for a neural network 102. In FIG. 1, the neural network 102 is configured to receive input data and output data, both represented in matrix format. The nodes of the neural network 102 are characterized by weights and biases, represented in weight and bias matrices having elements for each neuron in the neural network 102. The weight, bias, and input data values stored as matrix elements may include floating-point values that allow for a high level of precision in the data values and contribute to a high level of accuracy for the neural network. However, such precision also translates to higher storage requirements and slower floating point computations (as compared to integer computations) unless adjustments are made.

In various implementations, quantization is applied to the weight and bias parameter values and the input data values to reduce the storage requirements, reduce network load, increase power efficiency, and/or increase computation performance. As such, in at least one implementation, the process of quantization reduces the precision of weights, biases, and input data to consume less memory and enhance computation performance. For example, quantization can convert weights, biases, and input data, which may be represented as 32-bit floating point numbers, to 8-bit integers using one or more scaling factors before being input to the neural network 102. Converting the weight and bias parameter values from 32-bit floating point numbers to 8-bit integers reduces the neural network model by a factor of four, resulting in a significant reduction in memory. Likewise, converting these values to integers also enhances computational performance. However, the selection of ill-advised scaling factors for such quantization can also unacceptably reduce model accuracy as the precision of these values may truncated to yield integer values. Accordingly, the selection of appropriate scaling factors has significant implications on the performance and accuracy of a neural network model.

As shown in FIG. 1, rather than inputting the raw weight, bias, and input data values to the neural network 102, this data is quantized (e.g., using scaling factors) before being input to the neural network 102. Accordingly, the input data is input as a quantized input data matrix 104 after the raw input data has been quantized (e.g., by an input data scaling factor selected in accordance with the described technology), the weight values are input as a quantized weight matrix 108 after the raw weight data has been quantized (e.g., by a weight scaling factor selected in accordance with the described technology), and the bias data is input as a quantized bias matrix 110 after the raw bias has been quantized (e.g., by a bias scaling factor selected in accordance with the described technology). Furthermore, the quantized output data matrix 106 output from the neural network 102 can be subsequently scaled down, unquantized, or de-quantized to yield the raw output data.

For example, neural networks often consist of linear layers (e.g., WA+B above), followed by an activation function f, such as ReLU, Sigmoid, Tanh etc. An activation matrix is the output of the activation function. However, one would probably de-quantize the quantized output data matrix 106 before passing it to the activation function because the activation function is usually nonlinear. As such, passing a quantized version of the quantized output data matrix 106 to the activation function might cause undesired results (e.g., results that are completely different from running the neural network without quantization). In other words, the workflow could work like this:
1. input: W, A, B
2. quantize W, A, and B to get W′, A′, and B′
3. compute C′=W′A′+B′
4. de-quantize C′ to get C
5. apply activation function f to C to get the activation matrix f(C)

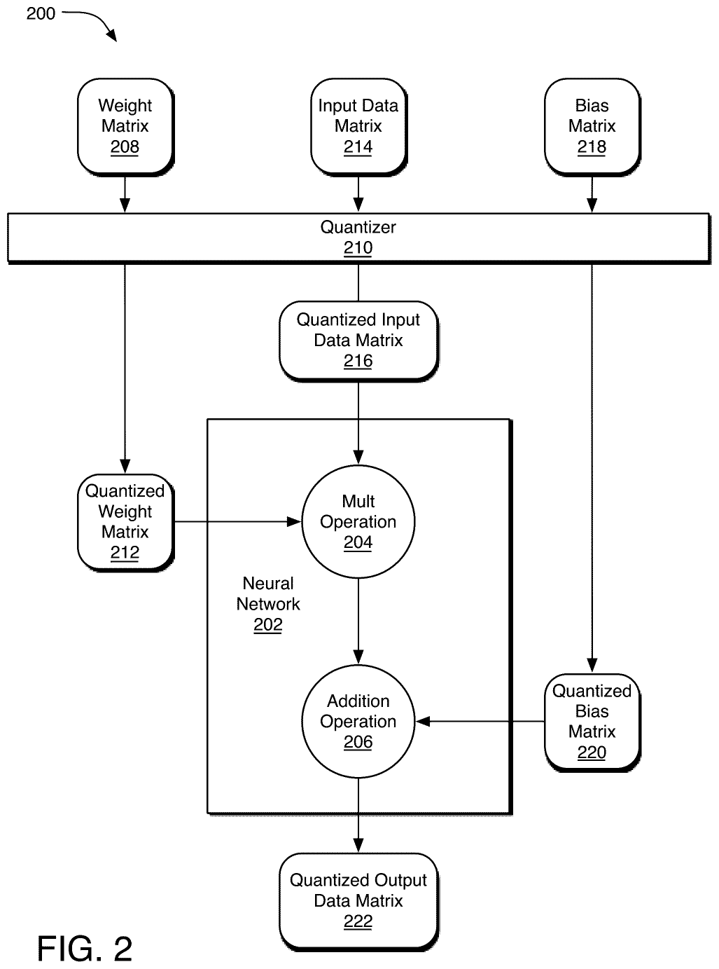

FIG. 2 illustrates an example system 200 for quantizing weight values, input data values, and bias values for a neural network 202. The neural network 202 is shown as implementing a linear operation (e.g., including a multiplication operation 204 and an addition operation 206), although other linear operations may be employed using the described technology. A weight matrix 208 includes raw weight values and is input to a quantizer 210, which yields a quantized weight matrix 212 (referred to as matrix W). An input data matrix 214 includes raw input data values and is input to the quantizer 210, which yields a quantized input data matrix 216 (referred to as matrix A). A bias matrix 218 includes raw bias values and is input to the quantizer 210, which yields a quantized bias matrix 220 (referred to as matrix B).

In its implementation of the linear operation WA+B, the neural network 202 multiplies the elements of the quantized input data matrix 216 with corresponding elements of the quantized weight matrix 212 (see multiplication operation 204) and adds the elements of the resulting product matrix (not shown) to the quantized bias matrix 220 to yield the sum as a quantized output data matrix 222. The elements of the quantized output data matrix 222 are then scaled back to provide the raw output data (not shown).

In the described technology, accurate quantization is achieved by a value-dependent selection of scaling factors. For example, in one implementation, the scaling factors selected for quantization of the weight matrix and the input data matrix are based on the values in these matrices, in contrast to determining the scaling factors merely as a function of the dimensions of the weight matrix and the input data matrix. Furthermore, in some implementations, scaling factor determination for the weight matrix and the input data matrix is also based on values of the bias matrix and vice versa (e.g., scaling factor determination for the bias matrix is based on values of the weight matrix and the input data matrix).

In various implementations of the described technology, values of weights, input data, and biases are embedded in a field [symbol] ₚ of integers modulo a prime p to determine a maximum field size for a field containing values of a quantized version of a weight matrix, a quantized version of an input data matrix, and a quantized version of a bias matrix. A maximum value of the prime p for the linear operations of WA+B is derived such that the wrap around error is avoided for a 64-bit implementation, for example:

$${n ( p - 1 )}^{2} + p - 1 \leq {2}^{64} - 1 \qquad ( 1 )$$

$${\to }^{yields} p \leq \frac{2 n - 1 + \sqrt{1 + 4 n ( {2}^{64} - 1 )}}{2 n} \qquad ( 2 )$$

where n is the second dimension of W, the first dimension of A, and the maximum size of the field [symbol] ₚ of integers is set to p. Generally, p satisfies the inequality (2), so one can simply pick any prime p that satisfies the inequality. Typically, the largest possible p is selected, subject to the conditions that it (a) satisfies the inequality (2) and (b) is a prime number.

Having determined the maximum size of the field [symbol] ₚ, the upper bound on the scale factors to be applied to each of the matrices W, A, and B is determined based on the values of elements of each matrix and the maximum field size, such that the quantized values of these elements in each matrix are also in the field [symbol] ₚ. In this implementation, it is assumed that the scale factors are powers of two (e.g., for scaling up W, each element is multiplied by the scaling factor 2^{l}^{_{W}}, where l_{W} denotes the determined scaling parameter corresponding to W), although different scaling factor constraints may be imposed. Similarly, the scale factors of matrices A and B are denoted by 2^{l}^{_{A}} and 2^{l}^{_{B}}, respectively, where l_{A} denotes the determined scaling parameter corresponding to A and l_{B} denotes the determined scaling parameter corresponding to B. In the field [symbol] ₚ, all values in quantized versions of the matrices W, A, and B are within the range of—(p−1)/2 and (p−1)/2. Therefore:

$$- \frac{p - 1}{2} \leq {2}^{{l}_{I}} \times I \leq \frac{p - 1}{2} {\to }^{yields} {l}_{I} \leq {log}_{2} \frac{p - 1}{2 max \vert I \vert} , \qquad ( 3 )$$

where I ∈{W, A, B}, and max|I| is the maximum absolute value among the elements of matrix I. Note that as all elements of matrix I are multiplied with the same scale factor, and the limiting term for determining the upper bound of the scale factor is the maximum absolute value of the matrix (e.g., max|I|). Accordingly, in various implementations, the determination of an upper bound of a scaling factor for each matrix based on values of elements of the matrix and the maximum field size

Having determined the upper bound of the scale factors for the values of the matrices W, A, and B, the scaling factors for each matrix W, A and B are then determined. For the matrix multiplication of WA, the upper bounds found in Equation (3) are used as the scale factors—the scaled version of W is equal to

$${W}^{′} = W \times {2}^{{l}_{W}^{max}} , {l}_{W}^{max} = {log}_{2} \frac{p - 1}{2 max \vert W \vert}$$

and the scaled version of A is equal to

$${A}^{′} = A \times {2}^{{l}_{A}^{max}} , {l}_{A}^{max} = {log}_{2} \frac{p - 1}{2 max \vert A \vert} .$$

However, when bias addition is also applied—WA+B, the scaled factor of B should match that of W and A in a sense that the condition of 2^{l}^{_{W}}×2^{l}^{_{A}}=2^{l}^{_{B}} or, equivalently, l_{W}+l_{A}=l_{B} should be satisfied. To satisfy this condition, two cases are considered:

$$( i ) {l}_{W}^{max} + {l}_{A}^{max} \leq {l}_{B}^{max} , and \\ ( ii ) {l}_{W}^{max} + {l}_{A}^{max} > {l}_{B}^{max} ,$$

and for each case, tuned or optimal values of the scale factors that result in the minimum quantization error are determined, as discussed below:

Case: l_{W}^{max}+l_{A}^{max}≤l_{B}^{max}:

In this case, to satisfy the condition of l_{W}+l_{A}=l_{B}, l_{W} and l_{A} are set to their maximum values, and l_{B} is set to the summation of l_{W} and l_{A}. In this way, the condition of l_{W}+l_{A}=l_{B} is satisfied while the maximum scaling factor is assigned for quantizing W and A. Note that the maximum scaling factor for quantizing B is not satisfied here due to the constraint of l_{W}+l_{A}=l_{B}. The following equations summarize the scaling factor assigned for quantizing W, A and B for the case of l_{W}^{max}+l_{A}^{max}≤l_{B}^{max}:

$${l}_{W} = {l}_{W}^{max} \qquad ( 4 )$$

$${l}_{A} = {l}_{A}^{max} \qquad ( 5 )$$

$${l}_{B} = {l}_{W}^{max} + {l}_{A}^{max} \qquad ( 6 )$$

Case: l_{W}^{max}+l_{A}^{max}>l_{B}^{max}:

In this case, the limiting factor is (max, therefore, l_{B}^{max} is set to its upper bound of l_{B}^{max}, and l_{W} and l_{A} are set based on l_{B}^{max}. The values of l_{W} and l_{A} are assigned such that the quantization error is minimized. In this way, the loss in accuracy is reduced when this quantization method is applied to the weights and input data for a neural network calculation. The details of an example implementation for setting l_{W} and l_{A} are provided below.

Through analysis of how the quantization factors affect the error, the following choice of scaling factors has been derived to minimize errors defined using the [symbol] ^{∞} and [symbol] ¹ norms, as shown in Table 1 below.

TABLE 1
Derivation of Scaling Factors

| | α | β |
|---|---|---|
| [symbol] ^{∞} norm | $\sqrt{\frac{κ {max}_{k ∈ [ h ]} ( {Σ}_{j ∈ [ n ]} \vert {a}_{j , k} \vert )}{{max}_{i ∈ [ m ]} ( {Σ}_{j ∈ [ n ]} \vert {w}_{i j} \vert )}}$ | $\sqrt{\frac{κ {max}_{i ∈ [ m ]} ( {Σ}_{j ∈ [ n ]} \vert {w}_{i , j} \vert )}{{max}_{k ∈ [ h ]} ( {Σ}_{j ∈ [ n ]} \vert {a}_{j , k} \vert )}}$ |
| [symbol] ¹ norm | $\sqrt{\frac{κ m {Σ}_{j ∈ [ n ] , k ∈ [ h ]} \vert {a}_{j , k} \vert}{h {Σ}_{i ∈ [ m ] , j ∈ [ n ]} \vert {w}_{i , j} \vert}}$ | $\sqrt{\frac{κ h {Σ}_{i ∈ [ m ] , j ∈ [ n ]} \vert {w}_{i , j} \vert}{m {Σ}_{j ∈ [ n ] , k ∈ [ h ]} \vert {a}_{j , k} \vert}}$ |

In Table 1, α_{i,j} (respectively w_{i,j}) is the (i, j)-th entry of the matrix A (respectively W), κ=α×β=l_{B}^{max}, α=2^{l}^{_{W}}, β=2^{l}^{_{A}}, h is the second dimension of A, n is the first dimension of A, and m is the first dimension of W.

For determining l_{A} and l_{W}, one of them is first computed by replacing κ with l_{B}^{max} in the above table and then the other one is computed by using the equation of l_{W}+l_{A}=l_{B}^{max}.

In some implementations, the described quantization method is designed to minimize [symbol] ¹ norm. For example, in VGG16 inference trained on ImageNet dataset, the inference is broken down into layers, and then each layer is broken down into linear and nonlinear operations. Without quantization, the top-1 accuracy is equal to 71.258%, and the top-5 accuracy is equal to 90.042%. With the described quantization method applied to the linear operations of all convolutional layers as well as the fully connected layers and the prediction layer, little or no loss in accuracy was observed. In fact, with quantized inputs, weights and biases for the linear operations, the obtained accuracy is 71.26% for top-1 accuracy and 90.044% for top-5 accuracy.

In summary, the design of a good quantization method is challenging as quantizing data affects accuracy, especially in cases where the model is trained using non-quantized data. A new quantization method is described herein that is applicable in privacy-preserving and verifiable machine learning. Many cryptographic approaches used for secure machine learning work in finite fields. Therefore, in order to use these methods for privacy-preserving and verifiable machine learning, the parameters and input data used for the machine learning operations are converted to integers. It should be understood, however, that other technical benefits (e.g., computation efficiencies, storage efficiencies, communication efficiencies) may also result from the describe technology. Such conversion can be done by scaling up these parameters, doing the cryptographic operations on the scaled parameters, and then scaling down (e.g., “de-quantizing”) them back to the original domain.

Derivation details for these scaling factors are provided below.

### Minimizing the ^{∞} Norm of the Error

First, observe that, since κ=αβ is fixed by assumption, the “scaled” error can be tuned or minimized.

$$‖ ( ⌊ α W ⌉ ⌊ β A ⌉ + ⌊ α β B ⌉ ) - αβ ( WA + B ) ‖$$

wherein [⋅] denotes a rounding operator and ∥⋅∥ denotes a norm. [Inventors: Please confirm or correct the changes in this section.]

The problem of minimizing this error with respect to the [symbol] ∞ norm is considered. Let

$$E = ( ⌊ α W ⌉ ⌊ β A ⌉ + ⌊ αβ B ⌉ ) - αβ ( WA + B ) ,$$

so that e_{∞}=∥E∥_{∞}, and write
W=(w_{i,j})_{i∈[m],j∈[n]}, A=(a_{j,k})_{j∈[n],k∈[h]}, B=(b_{i,k})_{i∈[m],k∈[h]}, E=(e_{i,k})_{i∈[m],k∈[h]}.

Then

$${e}_{i , k} = {\sum }_{j ∈ [ n ]} ⌊ α {w}_{i , j} ⌉ ⌊ β {a}_{j , k} ⌉ + ⌊ αβ {b}_{i , k} ⌉ - αβ {\sum }_{j ∈ [ n ]} {w}_{i , j} {a}_{j , k} - αβ {b}_{i , k} \\ and \\ \begin{matrix}{{e}_{∞} = ‖ ( ⌊ α W ⌉ ⌊ β A ⌉ + ⌊ αβ B ⌉ ) - αβ ( WA + B ) ‖}_{∞} \\ = {max}_{i ∈ [ m ] , k ∈ [ h ]} \vert {\sum }_{j ∈ [ n ]} ⌊ α {w}_{i , j} ⌉ β {a}_{j , k} ⌉ + αβ {b}_{i , k} ⌉ - αβ {\sum }_{j ∈ [ n ]} {w}_{i , j} {a}_{j , k} - αβ {b}_{i , k} \vert\end{matrix} .$$

Since └αw_{i,j}┐ differs from αw_{i,j} by at most ½ (and similarly for the other terms), the following is obtained:

$$\begin{matrix}{e}_{∞} \leq {max}_{i ∈ [ m ] , k ∈ [ h ]} ( \frac{1}{2} α {\sum }_{j ∈ [ n ]} \vert {w}_{i , j} \vert + \frac{1}{2} β {\sum }_{j ∈ [ n ]} \vert {a}_{j , k} \vert + \frac{1}{4} n + \frac{1}{2} ) \\ = \frac{1}{2} α ( {max}_{i ∈ [ m ]} {\sum }_{j ∈ [ n ]} \vert {w}_{i , j} \vert ) + \frac{1}{2} β ( {max}_{k ∈ [ h ]} {\sum }_{j ∈ [ n ]} \vert {a}_{j , k} \vert ) + \frac{1}{4} n + \frac{1}{2}\end{matrix} .$$

The two rightmost terms can be ignored when minimizing e_{∞}. Thus, in order to minimize the [symbol] ^{∞} error, α and β are chosen such that

$$\frac{α}{β} = \frac{{max}_{k ∈ [ h ]} ( {\sum }_{j ∈ [ n ]} \vert {a}_{j , k} \vert )}{{max}_{i ∈ [ m ]} ( {\sum }_{j ∈ [ n ]} \vert {w}_{i , j} \vert )} .$$

As αβ=κ, solving these equations for α and β, the following are obtained:

$$α = \sqrt{\frac{κ {max}_{k ∈ [ h ]} ( {\sum }_{j ∈ [ n ]} \vert {a}_{j , k} \vert )}{{max}_{i ∈ [ m ]} ( {\sum }_{j ∈ [ n ]} \vert {w}_{i , j} \vert )}} and β = \sqrt{\frac{κ {max}_{i ∈ [ m ]} ( {\sum }_{j ∈ [ n ]} \vert {w}_{i , j} \vert )}{{max}_{κ ∈ [ h ]} ( {\sum }_{j ∈ [ n ]} \vert {a}_{j , k} \vert )}} .$$

### Minimizing the ¹ Norm of the Error

Next, the error defined by the [symbol] ¹ norm is considered:

$${{e}_{1} = {‖ E ‖}_{1} = ‖ ( ⌊ α W ⌉ ⌊ β A ⌉ + ⌊ αβ B ⌉ ) - αβ ( WA + B ) ‖}_{1} .$$

By a similar computation as above, the following is obtained:

$$\begin{matrix}{{e}_{1} = ‖ ( ⌊ α W ⌉ ⌊ β A ⌉ + ⌊ αβ B ⌉ ) - αβ ( WA + B ) ‖}_{1} \\ = {\sum }_{i ∈ [ m ] , k ∈ [ h ]} \vert {\sum }_{j ∈ [ n ]} ⌊ α {w}_{i , j} ⌉ ⌊ β {a}_{j , k} ⌉ + ⌊ αβ {b}_{i , k} ⌉ - \\ αβ {\sum }_{j ∈ [ n ]} {w}_{i , j} {a}_{j , k} - αβ {b}_{i , k} \vert \\ \leq {\sum }_{i ∈ [ m ] , k ∈ [ h ]} ( \frac{1}{2} α {\sum }_{j ∈ [ n ]} \vert {w}_{i , j} \vert + \frac{1}{2} β {\sum }_{j ∈ [ n ]} \vert {a}_{j , k} \vert + \frac{1}{4} n + \frac{1}{2} ) \\ = \frac{1}{2} α ( {\sum }_{i ∈ [ m ] , k ∈ [ h ]} {\sum }_{j ∈ [ n ]} \vert {w}_{i , j} \vert ) + \frac{1}{2} β ( {\sum }_{i ∈ [ m ] , k ∈ [ h ]} {\sum }_{j ∈ [ n ]} \vert {a}_{j , k} \vert ) + \\ \frac{1}{4} nmh + \frac{1}{2} mh\end{matrix} .$$

Again, the two rightmost terms can be ignored in the summation when trying to minimize the error. Thus, α and β are chosen such that

$$\frac{α}{β} = \frac{{\sum }_{i ∈ [ m ] , j ∈ [ n ] , k ∈ [ h ]} \vert {a}_{j , k} \vert}{{\sum }_{i ∈ [ m ] , j ∈ [ n ] , k ∈ [ h ]} \vert {w}_{i , j} \vert} = \frac{m {\sum }_{j ∈ [ n ] , k ∈ [ h ]} \vert {a}_{j , k} \vert}{h {\sum }_{i ∈ [ m ] , j ∈ [ n ]} \vert {w}_{i , j} \vert}$$

to minimize the error e₁ defined by the [symbol] ¹ norm. Solving for α and β gives the results shown in Table 1.

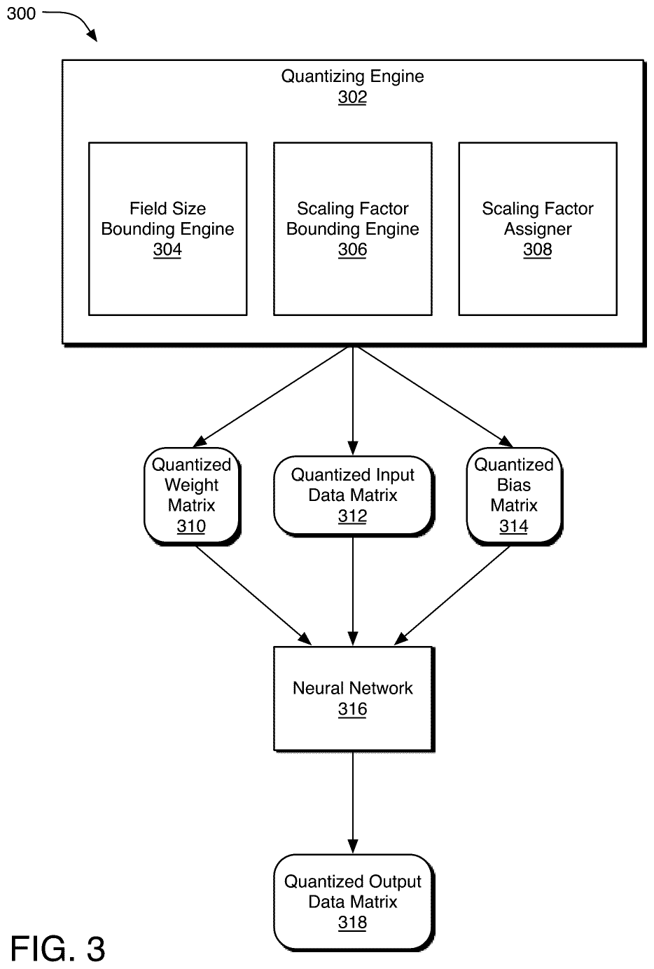

FIG. 3 illustrates an example computing system 300 for quantizing linear operations of neural network calculations. The computing system 300 includes one or more hardware computing processors to assist with executing software/firmware of elements of the computing system 300 and/or for communicating data to and/or from such elements. A quantizing engine 302 (e.g., a quantizer) receives raw weights, input data, and biases for value-based quantization.

A field size bounding engine 304 is executable by the one or more hardware computing processors and is configured to determine a maximum field size for a field containing values of a quantized version of a weight matrix, a quantized version of an input data matrix, and a quantized version of a bias matrix. Accordingly, referring to the detailed description of FIG. 2, in the field [symbol] ₚ, all values in quantized versions of the matrices W, A, and B are within the range of —(p−1)/2 and (p−1)/2.

A scaling factor bounding engine 306 is executable by the one or more hardware computing processors and is configured to determine a weight upper bound of scaling factors for the weight matrix based on values of elements of the weight matrix, an input data upper bound of scaling factors for the input data matrix based on values of elements of the input data matrix, and a bias upper bound of scaling factors for the bias matrix based on values of elements of the bias matrix. Accordingly, referring to Equation (3), all scaling factors for matrices W, A, and B are within

$${l}_{I} \leq {log}_{2} \frac{p - 1}{2 max \vert I \vert} .$$

A scaling factor assigner 308 is executable by the one or more hardware computing processors and is configured to set a weight scaling factor of the weight matrix to the weight upper bound, an input data scaling factor of the input data matrix to the input data upper bound, and a bias scaling factor for the bias matrix to a sum of the weight upper bound and the input data upper bound, when the sum is less than or equal to the bias upper bound (e.g., when l_{W}^{max}+l_{A}^{max}≤l_{B}^{max}), and to set the bias scaling factor for the bias matrix to the bias upper bound and the weight scaling factor of the weight matrix and the input data scaling factor of the input data matrix based on the bias upper bound, when the sum is greater than the bias upper bound (e.g., when l_{W}^{max}+l_{A}^{max}>l_{B}^{max}).

The quantizing engine 302 outputs a quantized weight matrix 310, a quantized input data matrix 312, and a quantized bias matrix 314, which can be input to a neural network 316 for computing a linear operation. The neural network 316 outputs quantized output data 318 based on the linear operations. In some implementations, the quantized output data 318 can be scaled down or de-quantized by the quantizing engine 302 or another entity.

The computing system 300 may also include a neural network executable by the one or more hardware computing processors and configured to perform an inference on a linear operation as a function of the weight matrix, the input data matrix, and the bias matrix using a neural network.

The computing system 300 may also include a quantizing engine executable by the one or more hardware computing processors and configured to quantize the weight matrix based on the weight scaling factor to yield a quantized weight matrix, to quantize the input data matrix based on the input data scaling factor to yield a quantized input data matrix, and to quantize the bias matrix based on the bias scaling factor to yield a quantized bias matrix, and a neural network executable by the one or more hardware computing processors and configured to perform an inference on a linear operation as a function of the quantized weight matrix, the quantized input data matrix, and the quantized bias matrix using a neural network to yield a quantized output matrix.

In some implementations, the quantizing engine is further configured to de-quantize the quantized output matrix to yield a scaled-down output matrix.

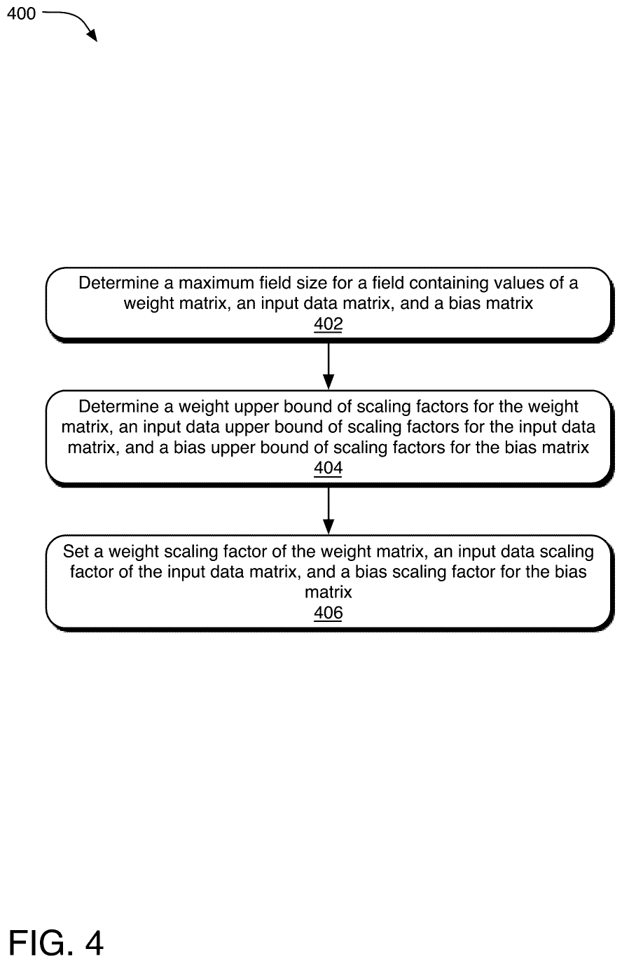

FIG. 4 illustrates example operations 400 of a computing-processor-implemented method for quantizing linear operations of neural network calculations. A field size operation 402 determines a maximum field size for a field containing values of a quantized version of a weight matrix, a quantized version of an input data matrix, and a quantized version of a bias matrix. A scaling factor bounding operation 404 determines a weight upper bound of scaling factors for the weight matrix based on values of elements of the weight matrix, an input data upper bound of scaling factors for the input data matrix based on values of elements of the input data matrix, and a bias upper bound of scaling factors for the bias matrix based on values of elements of the bias matrix. A scaling factor assigning operation 406 sets a weight scaling factor of the weight matrix to the weight upper bound, an input data scaling factor of the input data matrix to the input data upper bound, and a bias scaling factor for the bias matrix to a sum of the weight upper bound and the input data upper bound, when the sum is less than or equal to the bias upper bound (e.g., when l_{W}^{max}+l_{A}^{max}≤l_{B}^{max}), and sets the bias scaling factor for the bias matrix to the bias upper bound and the weight scaling factor of the weight matrix and the input data scaling factor of the input data matrix based on the bias upper bound, when the sum is greater than the bias upper bound (e.g., when l_{W}^{max}+l_{A}^{max}>l_{B}^{max}).

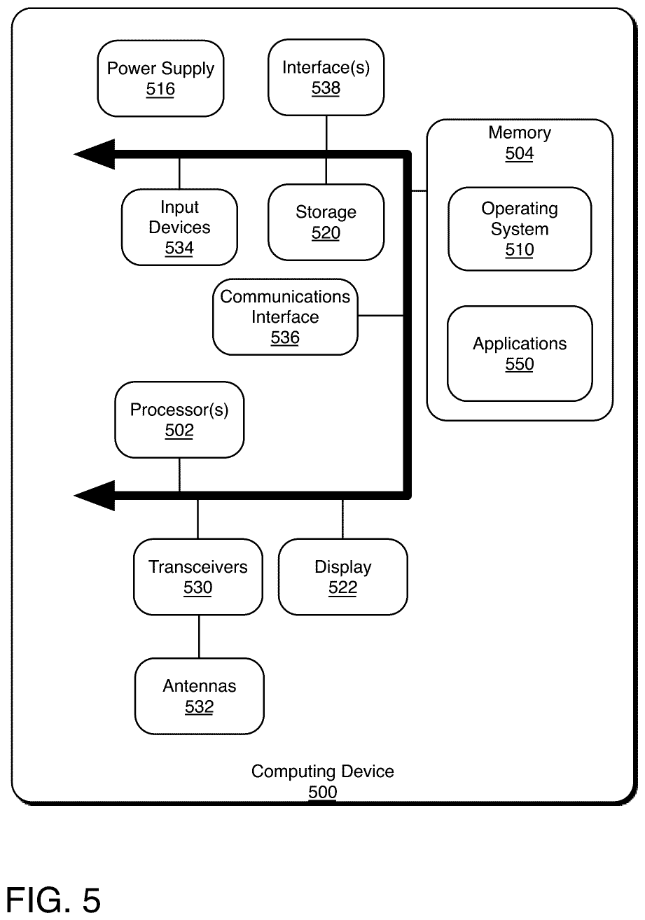

FIG. 5 illustrates an example computing device 500 for use in implementing the described technology. The computing device 500 may be a client computing device (such as a laptop computer, a desktop computer, or a tablet computer), a server/cloud computing device, an Internet-of-Things (IoT), any other type of computing device, or a combination of these options. The computing device 500 includes one or more hardware processor(s) 502 and a memory 504. The memory 504 generally includes both volatile memory (e.g., RAM) and nonvolatile memory (e.g., flash memory), although one or the other type of memory may be omitted. An operating system 510 resides in the memory 504 and is executed by the processor(s) 502. In some implementations, the computing device 500 includes and/or is communicatively coupled to storage 520.

In the example computing device 500, as shown in FIG. 5, one or more software modules, segments, and/or processors, such as applications 550, quantizer or quantization engine, a field size bounding engine, a scaling factor bounding engine, a scaling factor assigner, a neural network, and other program code and modules are loaded into the operating system 510 on the memory 504 and/or the storage 520 and executed by the processor(s) 502. The storage 520 may store weights, input data, output data, biases, matrices, and other data and be local to the computing device 500 or may be remote and communicatively connected to the computing device 500. In one implementation, components of a system for quantizing linear operations of neural network calculations may be implemented entirely in hardware or in a combination of hardware circuitry and software.

The computing device 500 includes a power supply 516, which may include or be connected to one or more batteries or other power sources, and which provides power to other components of the computing device 500. The power supply 516 may also be connected to an external power source that overrides or recharges the built-in batteries or other power sources.

The computing device 500 may include one or more communication transceivers 530, which may be connected to one or more antenna(s) 532 to provide network connectivity (e.g., mobile phone network, Wi-Fi®, Bluetooth®) to one or more other servers, client devices, IoT devices, and other computing and communications devices. The computing device 500 may further include a communications interface 536 (such as a network adapter or an I/O port, which are types of communication devices). The computing device 500 may use the adapter and any other types of communication devices for establishing connections over a wide-area network (WAN) or local-area network (LAN). It should be appreciated that the network connections shown are exemplary and that other communications devices and means for establishing a communications link between the computing device 500 and other devices may be used.

The computing device 500 may include one or more input devices 534 such that a user may enter commands and information (e.g., a keyboard, trackpad, or mouse). These and other input devices may be coupled to the server by one or more interfaces 538, such as a serial port interface, parallel port, or universal serial bus (USB). The computing device 500 may further include a display 522, such as a touchscreen display.

The computing device 500 may include a variety of tangible processor-readable storage media and intangible processor-readable communication signals. Tangible processor-readable storage can be embodied by any available media that can be accessed by the computing device 500 and can include both volatile and nonvolatile storage media and removable and non-removable storage media. Tangible processor-readable storage media excludes intangible and transitory communications signals (such as signals per se) and includes volatile and nonvolatile, removable and non-removable storage media implemented in any method, process, or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 500. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A computing-processor-implemented method for quantizing linear operations of machine learning computations, the computing-processor-implemented method comprising: determining a maximum field size for a field containing values of a quantized version of a weight matrix, a quantized version of an input data matrix, and a quantized version of a bias matrix; determining a weight upper bound of scaling factors for the weight matrix based on values of elements of the weight matrix and the maximum field size, an input data upper bound of scaling factors for the input data matrix based on values of elements of the input data matrix and the maximum field size, and a bias upper bound of scaling factors for the bias matrix based on values of elements of the bias matrix and the maximum field size; setting a weight scaling factor of the weight matrix to the weight upper bound, an input data scaling factor of the input data matrix to the input data upper bound, and a bias scaling factor for the bias matrix to a sum of the weight upper bound and the input data upper bound, when the sum is less than or equal to the bias upper bound; and setting the bias scaling factor for the bias matrix to the bias upper bound and the weight scaling factor of the weight matrix and the input data scaling factor of the input data matrix based on the bias upper bound, when the sum is greater than the bias upper bound.

Clause 2. The computing-processor-implemented method of clause 1, further comprising: performing an inference on a linear operation as a function of the weight matrix, the input data matrix, and the bias matrix using a neural network.

Clause 3. The computing-processor-implemented method of clause 2, wherein the linear operation includes a multiplication as a function of the weight matrix and the input data matrix to yield a product matrix.

Clause 4. The computing-processor-implemented method of clause 3, wherein the linear operation includes an addition operation as a function of the product matrix and the bias matrix.

Clause 5. The computing-processor-implemented method of clause 1, further comprising: quantizing the weight matrix based on the weight scaling factor to yield a quantized weight matrix; quantizing the input data matrix based on the input data scaling factor to yield a quantized input data matrix; quantizing the bias matrix based on the bias scaling factor to yield a quantized bias matrix; and performing an inference on a linear operation as a function of the quantized weight matrix, the quantized input data matrix, and the quantized bias matrix using a neural network to yield a quantized output matrix.

Clause 6. The computing-processor-implemented method of clause 5, further comprising: de-quantizing the quantized output matrix to yield a scaled-down output matrix.

Clause 7. The computing-processor-implemented method of clause 5, wherein the linear operation includes a multiplication of the quantized weight matrix and the quantized input data matrix that yields a product matrix and an addition of the product matrix to the quantized bias matrix.

Clause 8. A computing system for quantizing linear operations of machine learning computations, the computing system comprising: one or more hardware computing processors; a field size bounding engine executable by the one or more hardware computing processors and configured to determine a maximum field size for a field containing values of a quantized version of a weight matrix, a quantized version of an input data matrix, and a quantized version of a bias matrix; a scaling factor bounding engine executable by the one or more hardware computing processors and configured to determine a weight upper bound of scaling factors for the weight matrix based on values of elements of the weight matrix and the maximum field size, an input data upper bound of scaling factors for the input data matrix based on values of elements of the input data matrix and the maximum field size, and a bias upper bound of scaling factors for the bias matrix based on values of elements of the bias matrix and the maximum field size; and a scaling factor assigner executable by the one or more hardware computing processors and configured to set a weight scaling factor of the weight matrix to the weight upper bound, an input data scaling factor of the input data matrix to the input data upper bound, and a bias scaling factor for the bias matrix to a sum of the weight upper bound and the input data upper bound, when the sum is less than or equal to the bias upper bound and to set the bias factor for the bias matrix to the bias upper bound and the weight scaling factor of the weight matrix and the input data scaling factor of the input data matrix based on the bias upper bound, when the sum is greater than the bias upper bound.

Clause 9. The computing system of clause 8, further comprising: a neural network executable by the one or more hardware computing processors and configured to perform an inference on a linear operation as a function of the weight matrix, the input data matrix, and the bias matrix using a neural network.

Clause 10. The computing system of clause 9, wherein the linear operation includes a multiplication as a function of the weight matrix and the input data matrix to yield a product matrix.

Clause 11. The computing system of clause 10, wherein the linear operation includes an addition operation as a function of the product matrix and the bias matrix.

Clause 12. The computing system of clause 8, further comprising: a quantizing engine executable by the one or more hardware computing processors and configured to quantize the weight matrix based on the weight scaling factor to yield a quantized weight matrix, quantize the input data matrix based on the input data scaling factor to yield a quantized input data matrix, and quantize the bias matrix based on the bias scaling factor to yield a quantized bias matrix; and a neural network executable by the one or more hardware computing processors and configured to perform an inference on a linear operation as a function of the quantized weight matrix, the quantized input data matrix, and the quantized bias matrix using a neural network to yield a quantized output matrix.

Clause 13. The computing system of clause 12, wherein the quantizing engine is further configured to de-quantize the quantized output matrix to yield a scaled-down output matrix.

Clause 14. The computing system of clause 12, wherein the linear operation includes a multiplication of the quantized weight matrix and the quantized input data matrix that yields a product matrix and an addition of the product matrix to the quantized bias matrix.

Clause 15. One or more tangible processor-readable storage media embodied with instructions for executing on one or more processors and circuits of a computing device a process for quantizing linear operations of machine learning computations, the process comprising: determining a maximum field size for a field containing values of a quantized version of a weight matrix, a quantized version of an input data matrix, and a quantized version of a bias matrix; determining a weight upper bound of scaling factors for the weight matrix based on values of elements of the weight matrix and the maximum field size, an input data upper bound of scaling factors for the input data matrix based on values of elements of the input data matrix and the maximum field size, and a bias upper bound of scaling factors for the bias matrix based on values of elements of the bias matrix and the maximum field size; setting a weight scaling factor of the weight matrix to the weight upper bound, an input data scaling factor of the input data matrix to the input data upper bound, and a bias scaling factor for the bias matrix to a sum of the weight upper bound and the input data upper bound, when the sum is less than or equal to the bias upper bound; and setting the bias scaling factor for the bias matrix to the bias upper bound and the weight scaling factor of the weight matrix and the input data scaling factor of the input data matrix based on the bias upper bound, when the sum is greater than the bias upper bound.

Clause 16. The one or more tangible processor-readable storage media of clause 15, wherein the process further comprises: performing an inference on a linear operation as a function of the weight matrix, the input data matrix, and the bias matrix using a neural network.

Clause 17. The one or more tangible processor-readable storage media of clause 16, wherein the linear operation includes a multiplication as a function of the weight matrix and the input data matrix to yield a product matrix and an addition operation as a function of the product matrix and the bias matrix.

Clause 18. The one or more tangible processor-readable storage media of clause 15, wherein the process further comprises: quantizing the weight matrix based on the weight scaling factor to yield a quantized weight matrix; quantizing the input data matrix based on the input data scaling factor to yield a quantized input data matrix; quantizing the bias matrix based on the bias scaling factor to yield a quantized bias matrix; and performing an inference on a linear operation as a function of the quantized weight matrix, the quantized input data matrix, and the quantized bias matrix using a neural network to yield a quantized output matrix.

Clause 19. The one or more tangible processor-readable storage media of clause 18, wherein the process further comprises: de-quantizing the quantized output matrix to yield a scaled-down output matrix.

Clause 20. The one or more tangible processor-readable storage media of clause 18, wherein the linear operation includes a multiplication of the quantized weight matrix and the quantized input data matrix that yields a product matrix and an addition of the product matrix to the quantized bias matrix.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A computing-processor-implemented method for quantizing linear operations of machine learning computations, the computing-processor-implemented method comprising:
determining a maximum field size for a field containing values of a quantized version of a weight matrix, a quantized version of an input data matrix, and a quantized version of a bias matrix;
determining a weight upper bound of scaling factors for the weight matrix based on values of elements of the weight matrix and the maximum field size, an input data upper bound of scaling factors for the input data matrix based on values of elements of the input data matrix and the maximum field size, and a bias upper bound of scaling factors for the bias matrix based on values of elements of the bias matrix and the maximum field size;
setting a weight scaling factor of the weight matrix to the weight upper bound, an input data scaling factor of the input data matrix to the input data upper bound, and a bias scaling factor for the bias matrix to a sum of the weight upper bound and the input data upper bound, when the sum is less than or equal to the bias upper bound; and
setting the bias scaling factor for the bias matrix to the bias upper bound and the weight scaling factor of the weight matrix and the input data scaling factor of the input data matrix based on the bias upper bound, when the sum is greater than the bias upper bound.

2. The computing-processor-implemented method of claim 1, further comprising:
performing an inference on a linear operation as a function of the weight matrix, the input data matrix, and the bias matrix using a neural network.

3. The computing-processor-implemented method of claim 2, wherein the linear operation includes a multiplication as a function of the weight matrix and the input data matrix to yield a product matrix.

4. The computing-processor-implemented method of claim 3, wherein the linear operation includes an addition operation as a function of the product matrix and the bias matrix.

5. The computing-processor-implemented method of claim 1, further comprising:
quantizing the weight matrix based on the weight scaling factor to yield a quantized weight matrix;
quantizing the input data matrix based on the input data scaling factor to yield a quantized input data matrix;
quantizing the bias matrix based on the bias scaling factor to yield a quantized bias matrix; and
performing an inference on a linear operation as a function of the quantized weight matrix, the quantized input data matrix, and the quantized bias matrix using a neural network to yield a quantized output matrix.

6. The computing-processor-implemented method of claim 5, further comprising:
de-quantizing the quantized output matrix to yield a scaled-down output matrix.

7. The computing-processor-implemented method of claim 5, wherein the linear operation includes a multiplication of the quantized weight matrix and the quantized input data matrix that yields a product matrix and an addition of the product matrix to the quantized bias matrix.

8. A computing system for quantizing linear operations of machine learning computations, the computing system comprising:
one or more hardware computing processors;
a field size bounding engine executable by the one or more hardware computing processors and configured to determine a maximum field size for a field containing values of a quantized version of a weight matrix, a quantized version of an input data matrix, and a quantized version of a bias matrix;
a scaling factor bounding engine executable by the one or more hardware computing processors and configured to determine a weight upper bound of scaling factors for the weight matrix based on values of elements of the weight matrix and the maximum field size, an input data upper bound of scaling factors for the input data matrix based on values of elements of the input data matrix and the maximum field size, and a bias upper bound of scaling factors for the bias matrix based on values of elements of the bias matrix and the maximum field size; and
a scaling factor assigner executable by the one or more hardware computing processors and configured to set a weight scaling factor of the weight matrix to the weight upper bound, an input data scaling factor of the input data matrix to the input data upper bound, and a bias scaling factor for the bias matrix to a sum of the weight upper bound and the input data upper bound, when the sum is less than or equal to the bias upper bound and to set the bias scaling factor for the bias matrix to the bias upper bound and the weight scaling factor of the weight matrix and the input data scaling factor of the input data matrix based on the bias upper bound, when the sum is greater than the bias upper bound.

9. The computing system of claim 8, further comprising:
a neural network executable by the one or more hardware computing processors and configured to perform an inference on a linear operation as a function of the weight matrix, the input data matrix, and the bias matrix using a neural network.

10. The computing system of claim 9, wherein the linear operation includes a multiplication as a function of the weight matrix and the input data matrix to yield a product matrix.

11. The computing system of claim 10, wherein the linear operation includes an addition operation as a function of the product matrix and the bias matrix.

12. The computing system of claim 8, further comprising:
a quantizing engine executable by the one or more hardware computing processors and configured to quantize the weight matrix based on the weight scaling factor to yield a quantized weight matrix, quantize the input data matrix based on the input data scaling factor to yield a quantized input data matrix, and quantize the bias matrix based on the bias scaling factor to yield a quantized bias matrix; and
a neural network executable by the one or more hardware computing processors and configured to perform an inference on a linear operation as a function of the quantized weight matrix, the quantized input data matrix, and the quantized bias matrix using a neural network to yield a quantized output matrix.

13. The computing system of claim 12, wherein the quantizing engine is further configured to de-quantize the quantized output matrix to yield a scaled-down output matrix.

14. The computing system of claim 12, wherein the linear operation includes a multiplication of the quantized weight matrix and the quantized input data matrix that yields a product matrix and an addition of the product matrix to the quantized bias matrix.

15. One or more tangible processor-readable storage media embodied with instructions for executing on one or more processors and circuits of a computing device a process for quantizing linear operations of machine learning computations, the process comprising:
determining a maximum field size for a field containing values of a quantized version of a weight matrix, a quantized version of an input data matrix, and a quantized version of a bias matrix;
determining a weight upper bound of scaling factors for the weight matrix based on values of elements of the weight matrix and the maximum field size, an input data upper bound of scaling factors for the input data matrix based on values of elements of the input data matrix and the maximum field size, and a bias upper bound of scaling factors for the bias matrix based on values of elements of the bias matrix and the maximum field size;
setting a weight scaling factor of the weight matrix to the weight upper bound, an input data scaling factor of the input data matrix to the input data upper bound, and a bias scaling factor for the bias matrix to a sum of the weight upper bound and the input data upper bound, when the sum is less than or equal to the bias upper bound; and
setting the bias scaling factor for the bias matrix to the bias upper bound and the weight scaling factor of the weight matrix and the input data scaling factor of the input data matrix based on the bias upper bound, when the sum is greater than the bias upper bound.

16. The one or more tangible processor-readable storage media of claim 15, wherein the process further comprises:
performing an inference on a linear operation as a function of the weight matrix, the input data matrix, and the bias matrix using a neural network.

17. The one or more tangible processor-readable storage media of claim 16, wherein the linear operation includes a multiplication as a function of the weight matrix and the input data matrix to yield a product matrix and an addition operation as a function of the product matrix and the bias matrix.

18. The one or more tangible processor-readable storage media of claim 15, wherein the process further comprises:
quantizing the weight matrix based on the weight scaling factor to yield a quantized weight matrix;
quantizing the input data matrix based on the input data scaling factor to yield a quantized input data matrix;
quantizing the bias matrix based on the bias scaling factor to yield a quantized bias matrix; and
performing an inference on a linear operation as a function of the quantized weight matrix, the quantized input data matrix, and the quantized bias matrix using a neural network to yield a quantized output matrix.

19. The one or more tangible processor-readable storage media of claim 18, wherein the process further comprises:
de-quantizing the quantized output matrix to yield a scaled-down output matrix.

20. The one or more tangible processor-readable storage media of claim 18, wherein the linear operation includes a multiplication of the quantized weight matrix and the quantized input data matrix that yields a product matrix and an addition of the product matrix to the quantized bias matrix.
